(19) United States
(12) Patent Application Publication
(10) Pub. No.: US 2026/0318209 A1
(43) Pub. Date: Oct. 15, 2026

(54) TURBINE WHEEL FOR A TURBINE, IN PARTICULAR RADIAL TURBINE AND TURBINE CHARGER HAVING SUCH A TURBINE WHEEL

(71) Applicant: Rolls-Royce Solutions GmbH, Friedrichshafen (DE)

(72) Inventors: Martin Wiedmann, Reichenau (DE); Nico Staudinger, Baienfurt (DE); Friedrich Fröhlig, Ulm (DE)

(73) Assignee: Rolls-Royce Solutions GmbH, Friedrichshafen (DE)

(21) Appl. No.: 19/706,826

(22) Filed: Jun. 12, 2026

Related U.S. Application Data
(63) Continuation of application No. PCT/EP2024/086245, filed on Dec. 13, 2024.

(30) Foreign Application Priority Data
Dec. 13, 2023 (DE) 10 2023 135 028.5
Dec. 13, 2024 (WO) PCT/EP2024/086245

(51) Int. Cl. F01D 5/14

(52) U.S. Cl. CPC F01D 5/147; F05D 2220/40; F05D 2240/242

(57) ABSTRACT

A turbine wheel includes: a wheel body, including a central shaft region, a blade root region, and a plurality of turbine blades; and a gyroidal structure including a plurality of ribs, the central shaft region and the blade root region including a cavity limited by a wheel body wall defining the outer structure of the wheel body and traversed by the plurality of ribs of the gyroidal structure, the plurality of ribs within the cavity including a rib wall thickness, the wheel body wall including a wheel body wall thickness, at least one of (i) at least one of the rib wall thickness of the plurality of ribs and the wheel body wall thickness of the wheel body wall and (ii) a density of the gyroidal structure extending within the cavity is load-dependent with respect to forces acting on the wheel body during operation of the turbine wheel.

### CROSS REFERENCE TO RELATED APPLICATIONS

This is a continuation of PCT application no. PCT/EP2024/086245, entitled “TURBINE WHEEL FOR A TURBINE, IN PARTICULAR RADIAL TURBINE, AND TURBOCHARGER HAVING SUCH A TURBINE WHEEL”, filed Dec. 13, 2024, which is incorporated herein by reference. PCT application no. PCT/EP2024/086245 claims priority to German patent application no. 10 2023 135 028.5, filed Dec. 13, 2023, which is incorporated herein by reference.

### BACKGROUND OF THE INVENTION

### 1. Field of the Invention

The present invention relates to turbines.

### 2. Description of the Related Art

Turbine wheels are known from the state of the art, for example from DE 10 2009 049 841 B4. A turbocharger turbine is a turbomachine machine that uses the kinetic energy contained in flowing fluids, such as the exhaust gas of an internal combustion engine, to convert it into a rotary or rotational motion. The rotary or rotational movement can, for example, be provided via a shaft to a compressor, which can compress supply air by way of a compressor wheel and “charge” the engine with the compressed supply air.

Such a turbine wheel has a wheel body, optionally manufactured in one single piece, usually as a casting. The wheel body is designed to be rotatably arranged in a turbine housing and to be connected, at least rotationally fixed, to a shaft. The turbine housing can be designed as an axial or radial housing. The single-piece wheel body has a central shaft region, a blade root region, and a number of turbine blades. The blade root region also has a number of radial extensions associated with the turbine blades, each of which connects radially to the central shaft region which extends around the central axis of the wheel body and is integrally connected to the shaft region.

Typically, the wheel body of a turbine wheel, for example a cast part, is made of solid material and therefore has a continuous, solid internal structure; the casting is then further machined to achieve the complex geometry required for its specific application.

However, due to their essentially solid design, such turbine wheels exhibit a certain inertia, which, because of the varying mass flows, has a detrimental effect on the aforementioned compressor effect—particularly the dynamic response—of a turbocharger equipped with them.

In this respect, the requirements for a turbine wheel are specific; compared to a turbine wheel, rotating components in another area of compression—namely screw compressors—face significantly different requirements. For example, U.S. Pat. No. 11,047,387 B2 describes a screw compressor with two interlocking compressor screws arranged in parallel next to each other; these screws have internal cavities, such as honeycomb-like pockets, to reduce weight and, above all, to shift their natural frequencies to a higher frequency range; these are also referred to as rib structures or gyroidal structures. This is made possible by additive manufacturing processes such as 3D printing.

Processes, such as 3D printing, can now be advantageously implemented in additive manufacturing, including for the application of so-called “infill” structures; examples and characteristics of gyroscopic structures, using simple examples of objects without load requirements, are described in https://www.wevolver.com/article/understanding-the-gyroid-infill-in-3d-printing.

What is needed in the art is an improved turbine wheel for a turbine of a vehicle turbocharger, an arrangement including at least one turbine wheel and a compressor wheel, and a turbocharger for a vehicle with at least one single-piece wheel body that is in particular additively manufactured. In particular, the turbine wheel should have improved structural integrity, especially with regard to a required load capacity. Specifically, the structural integrity should be maintained even under dynamically changing loads, which are designed specifically for the operation of the turbine wheel.

### SUMMARY OF THE INVENTION

The present invention provides a turbine wheel, an arrangement or a turbocharger with at least one single-piece, in particular additively manufactured, wheel body, which describes at least one alternative design to the known structures. The present invention relates to a turbine wheel, in particular a radial turbine, of a turbocharger for a vehicle, in particular a motor vehicle, having at least one single-piece, in particular additively manufactured, wheel body, wherein the single-piece wheel body has a central shaft region, a blade root region and a number of turbine blades, wherein the blade root region has a number of radial extensions assigned to the turbine blades, wherein a turbine blade always connects integrally to a radial extension. The present invention moreover relates to an arrangement consisting of at least one turbine wheel and one compressor wheel, which are connected to each other by at least one shaft or can be connected to each other by way of a two-part shaft unit. In addition, the present invention relates to a turbocharger, in particular an exhaust gas turbocharger, for a vehicle.

The present invention provides, according to a first aspect, a turbine wheel, that is a turbine wheel for a turbine, in particular a radial turbine, a turbine charger for a vehicle, in particular a motor vehicle.

The present invention thus relates to the turbine wheel mentioned at the outset for a turbine, in particular a radial turbine, of a turbocharger for a vehicle, in particular a motor vehicle, with a single-piece, in particular additively manufactured, wheel body, which is designed to be rotatably arranged in a turbine housing, in particular a radial housing, and to be at least rotationally fixed to a shaft, wherein the single-piece wheel body includes
a central shaft region,
a blade root region, and
a number of turbine blades,
   wherein the blade root region has a number of radial extensions associated with the turbine blades, each of which connects radially to the central shaft region which extends about a central axis of the wheel body and is integrally connected to the shaft region, wherein a turbine blade is integrally connected to each radial extension.

According to the present invention, the present invention provides that at least the shaft region and the blade root region include a cavity bounded by a wheel body wall defining the outer structure of the wheel body and traversed by a number of ribs of a gyroidal structure.

The ribs within the cavity have a rib wall thickness, and the wheel body wall has a wheel body wall thickness, wherein the wall thickness of the ribs and/or the wheel body wall is designed to withstand the forces acting on the wheel body during the operation of the turbine wheel.

In addition, or alternatively, the density of the gyroidal structure extending within the cavity is designed to be load-dependent with respect to the forces acting on the wheel body during operation of the turbine wheel.

In other words, these aspects of wall thickness and/or density are defined specifically in relation to the forces acting on the wheel body during the operation of the turbine wheel.

By incorporating the aforementioned aspects of wall thickness and/or density of the gyroidal structure in the cavity region at the shaft and blade root region of the impeller body, which are defined based on the forces acting on the impeller body during turbine operation, the present invention aims to reduce the mass of the turbine impeller and, consequently, its inertia.

Even with dynamic changes in the mass flow acting on the turbine wheel, an improved response behavior is achieved, and in spite of the dynamic load acting on the turbine wheel, the wheel body maintains the required structural integrity.

Moreover, forces, which are designed according to the present invention, acting on the turbine wheel during operation can be absorbed especially effectively and transferred in a controlled manner via the gyroidal spatial structure in the shaft and blade root area of the wheel body to a shaft that can be coupled to the shaft area in a rotationally fixed manner, since the wall thickness of the ribs and/or the wheel body wall and/or the density of the gyroidal structure extending within the cavity is designed to be load-dependent with regard to the forces acting on the wheel body during the operation of the turbine wheel.

Turbine wheels which are continuously subjected to repetitive or changing forces and vibration loads can—by way of the structure designed according to the present invention in the shaft and blade root area of the wheel body—absorb forces acting on them and vibrations arising therefrom in an improved manner and without compromising the structural integrity of the wheel body and, if necessary, transfer them in a reduced magnitude to a shaft that can be coupled to it or is coupled to it.

According to the concept of the preset invention, the wall thickness of the ribs and/or the wheel body wall, or the density of the gyroidal structure extending within the cavity, is defined based on the forces acting on the wheel body during operation of the turbine wheel, particularly those forces that have been previously determined theoretically. In this way, sections or regions of the wheel body wall bounding the cavity, as well as of the gyroidal structure within the cavity in the shaft and blade root region of the wheel body, can be individually adapted to the forces expected to act on the turbine wheel.

The wall thickness of the ribs and/or the wheel body wall, or the density of the gyroidal structure extending in the cavity, is also determined, for example, by the size of the turbine wheel used.

Advantageous further developments of the present invention are specified in the dependent claims and relate in detail to advantageous possibilities of realizing the aforementioned concept within the scope of what is needed in the art and with regard to additional advantages.

According to a further development of the present invention, the wall thickness of the ribs of the gyroidal structure differs optionally from rib to rib and/or to the wheel body wall. Additionally, or alternatively, the wall thickness of the wheel body wall should also differ from wall to wall.

In particular, a varying wall thickness of the ribs and/or a varying wall thickness of the wheel body wall should be provided.

In particular, the density of the gyroidal structure within the cavity should vary. Optionally, the density of the gyroidal structure running within the cavity can be varied by, for example, varying the number of ribs per sub-region of the cavity from one sub-region to another.

By varying the wall thicknesses of the ribs and/or the wheel body walls, or by varying the density of the gyroidal structure in the cavity, it is possible to adapt the structural integrity of the wheel body in response to the forces acting on it during turbine wheel operation.

By varying the thickness of the ribs and/or the cavity walls and/or the density of the gyroidal structure within the cavity, it is possible to specifically influence the strength of the shaft and blade root regions on the impeller body, which in turn directly affects the structural integrity of the turbine impeller as a whole.

A varying wall thickness of the ribs and/or the wheel body wall and/or a varying density of the gyroidal structure in the region of the cavity at the shaft and blade root region of the wheel body, which are defined depending on the forces acting on the wheel body during operation of the turbine wheel, offers advantages in terms of integrity, load-bearing capacity even under changing loads, and weight advantages.

In an optional embodiment, the ribs of the gyroidal structure and/or the wheel body wall have a wall thickness that varies along their length, particularly with respect to the central axis of the wheel body along their axial, radial, and/or circumferential extent. Optionally, the wall thickness of both the ribs and the wheel body wall varies radially from the centerline of the wheel body. In particular, the wall thickness of the ribs and/or the wheel body wall decreases radially from the center axis. In an optional embodiment, the ribs are designed to be thicker in the connection area to a wheel body wall adjacent to the ribs—and thus in particular the root area of a rib connected to the wheel body wall—than further adjoining rib sections. In one possible configuration, the ribs of the gyroidal structure intersect at a kind of junction point, whereby such a junction point also optionally has a greater wall thickness compared to the ribs or rib sections extending away from the junction region.

According to a further development of the turbine wheel according to the present invention, the density of the gyroidal structure optionally varies in the radial and/or axial direction relative to the central axis of the wheel body. In particular, adjustment of the density of the gyroidal structure in radial and also axial directions is advantageous. This results in a targeted structural reinforcement of the wheel body in regions that are heavily subjected to the forces acting upon it. Furthermore, the overall structure of the wheel body is strengthened while an equally advantageous reduction in weight is achieved.

In particular, additive manufacturing, which is optional in conjunction with the production of the turbine wheel, makes it possible to create a reinforcement structure in the cavity of the shaft and blade root area of the wheel body that is individually adapted to the forces acting on the turbine wheel. Using additive manufacturing technology, the areas of the turbine blade subjected to the highest stresses can be structurally reinforced in a targeted manner, while the areas of the blade body subjected to lower stresses can be designed with greater flexibility in terms of their structural integrity.

One embodiment of the turbine wheel provides that the density of the gyroidal structure changes depending on the distance to the central axis, particularly linearly, wherein the density of the gyroidal structure optionally decreases with increasing distance to the central axis. By providing a higher density near the central axis of the turbine wheel compared to the density at points further away from the central axis, the gyroidal structure exhibits high strength in the region of the wheel body where the greatest forces or moments act, especially under dynamic loads that occur on the wheel body during operation of the turbine wheel operation. This further improves the structural integrity of the wheel body, which is designed to convert the kinetic energy contained in a gas flow into rotary motion to drive a shaft. Optionally, the density of the gyroidal structure changes, particularly linearly, depending on the distance from the central axis.

The density of the gyroidal structure changes, particularly linearly, optionally generally depending on the mechanical load for which the gyroidal structure is designed at the respective location. Conveniently, the density of the gyroidal structure increases, particularly linearly, in response to an increasing mechanical load, for which the gyroidal structure is designed at that respective location. Conveniently, the density of the gyroidal structure decreases, particularly linearly, in response to a decreasing mechanical load for which the gyroidal structure is designed at that respective location. In other words, the density of the gyroidal structure changes location-dependently with a location-dependent change in the load design of the turbine wheel.

A density that changes within the cavity decreases, particularly with increasing distance from the central axis. In one embodiment, the density of the gyroidal structure near the central axis can be approximately twice as great as the density of the region of the gyroidal structure that is furthest away in radial direction from the central axis.

In an optional embodiment, the shaft region is designed circular and/or annular around the center axis of the wheel body and is optionally arranged concentrically around the center axis of the wheel body together with the blade root region. The optionally annular design and the concentric arrangement of the shaft region together with the blade root region around the central axis result in an almost uniform mass distribution of the wheel body around the central axis, thereby counteracting any potential imbalance during operation of the turbine wheel. The turbine wheel is optionally designed so that the axis of rotation of the turbine wheel passes through the center of gravity of the wheel body. In particular, when combined with additive manufacturing technology, specifically 3D printing of such a wheel body, the position of the center of gravity relative to the axis of rotation of the wheel body can be influenced in a targeted manner.

Furthermore, it is provided that the wall thickness of the ribs that are furthest from the central axis has a ratio to the wall thickness of the ribs that are closest to the central axis in the range of about 0.25 to about 0.6, wherein optionally the ribs that are closest to the central axis have a wall thickness of about 1 to 6 mm, optionally 1.5 to 3 mm. With a wall thickness of 1 to 6 mm, optionally 1.5 to 3 mm, the ribs of the gyroidal structure at their smallest distance from the central axis provide the wheel body with sufficiently high strength to reliably transfer the dynamic loads occurring on the wheel body during operation of the turbine wheel from the shaft region to the shaft that can be coupled to the shaft area. The wall thickness of the ribs at the greatest distance from the central axis ranges from approximately 0.25 mm to approximately 3.6 mm, depending on the wall thickness of the ribs closest to the central axis, as specified above. The wall thickness of the ribs located between the sections with the smallest and greatest distances optionally changes linearly.

Optionally, the turbine wheel with its gyroidal structure, which includes at least one main gyroid, has a mass whose ratio to the mass of a turbine wheel made of solid material of the same size is in the range of 0.5 to 0.85, optionally in the range of 0.5 to 0.7. A turbine wheel equipped with such a gyroidal structure according to the present invention, arranged in the cavity of the shaft region and the blade root region, is optionally at least 15% lighter than a turbine wheel manufactured of solid material, optionally at least 30% lighter. In particular, when dynamic loads occur on the turbine wheel during operation, the reduced mass results in lower inherent stress on the turbine wheel. Furthermore, a significantly improved response is achieved with regard to speed adjustment to a changing mass flow. In an optional embodiment, the turbine wheel according to the present invention has a mass reduced by up to half the mass of a turbine wheel made of solid material, which further improves the response to changing dynamic loads acting upon it.

A further development of the turbine wheel provides that the structure, with respect to a cross-sectional area perpendicular to the central axis, has a number of ribs extending around the central axis, each of which oscillates in a wave-like manner about a circular line associated with the respective rib, wherein the circular lines extend around the central axis at different distances, and wherein the ribs optionally oscillate around the respective assigned circular line with an odd number of arcs of 3, 5, or 7. By way of the closed rib, which is optionally guided in an approximately wave-like manner around the center axis, an advantageous force absorption of any torques resulting from the dynamic loads on the wheel body is effected onto the gyroidal structure in the cavity of at least the shaft and blade root area of the wheel body. The optionally multiple wave-like ribs extending around the central axis of the wheel body at varying distances provide the gyroidal structure with high strength while simultaneously and advantageously reducing the mass of the otherwise solid shaft and blade root regions.

Depending on the magnitude of the forces expected to act on the turbine wheel, the number of arcs of the ribs extending around the central axis is adjusted. The ribs extending around the central axis each have optionally an odd number of arcs. A turbine wheel subjected to a comparatively low dynamic load has 3 arcs, whereas a turbine wheel subjected to a clearly higher dynamic load may have 5 or 7 arcs. Corresponding to the number of arcs, the ribs oscillate around a circular line assigned to each rib and extending concentrically to the center axis.

Optionally, the ribs have a number of wave crests projecting radially outward from the circular line and wave troughs projecting radially inward from the circular line, defined according to their number of arcs, wherein the size of the wave crests and wave troughs of the ribs relative to the circular line decreases with increasing distance of the ribs from the center axis. Optionally, the number of arcs is also used to influence the spacing of the gyroidal structure and thus the density of the gyroidal structure.

The greater the number of arcs, the smaller the spacing of the gyroidal structure that is formed within the cavity in the shaft or blade root region. Advantageously, in addition to the ribs extending around the central axis, the gyroidal structure also includes ribs or rib segments extending axially or radially, optionally depending on any cross-sectional planes passing through the wheel body.

The gyroidal structure within the turbine wheel cavity is optionally designed according to the stress(es) expected during operation of the turbine wheel. In particular, the cell size of the gyroidal structure in the cavity of the shaft and blade root region decreases depending on the location as the load increases depending on the location (that is, specifically with an increasing load to be expected according to a load design). Generally, with a locally increasing stress expected according to a stress analysis, the density of the gyroidal structure in the cavity of the shaft and blade root region can increase locally, particularly by decreasing cell sizes, as explained. Conversely, a locally decreasing stress can be addressed analogously, or, more generally, a locally changing stress can be addressed analogously.

In addition, or alternatively, the wall thickness of the ribs of the gyroidal structure can increase depending on the location as the load on the turbine wheel increases depending on the location. In particular the wall thickness of the ribs is selected to be thicker in regions subject to correspondingly high loads.

The measures mentioned are just some of several possibilities for addressing expected changes in stress depending on the location. Other options may be optional, but are not mandatory, involving location-dependent variations in the density and/or wall thickness of the ribs in the gyroidal structure within the cavity of the shaft and blade root region.

Optionally, the wave crests or troughs of two ribs arranged in a radial direction adjacent to each other are offset by a predetermined angle to each other, with the angular offset being in a range of approximately 10 to 20 degrees. This results in a further improved structural integrity of the gyroidal structure within the cavity of the shaft and blade root area of the turbine body. Dynamic loads and forces can be better absorbed by the offset wave crests and wave troughs within the gyroidal structure and diverted in the direction of the shaft that can be coupled with the turbine wheel. The turbine wheel optionally has a central region within the gyroidal structure around the central axis, which consists of solid material. The gyroidal structure with its ribs is then integrally attached to the outside of the central area made of the solid material.

In an optional embodiment, an odd number of ribs extending around the central axis form a first group of ribs, and an even number of ribs extending around the central axis form a second group of ribs, wherein the wave crests and wave troughs of the first and second groups lie on different axes, respectively, extending radially from the central axis of the wheel body. Depending on the density of the gyroidal structure, each group of ribs includes at least two or three of the wave-shaped ribs extending around the central axis. The number of ribs assigned to each group can vary depending on the size of the turbine wheel and the expected stress/dynamic load on the turbine wheel.

In an optional embodiment, the radial extensions of the blade root region taper cross sectionally in order to structurally and integrally connect the shaft region to the turbine blades, with the turbine blades optionally adjoining the tapered cross-section of the radial extensions in a blade-like manner. The tapered cross-section of the radial extensions creates an optionally smooth and thus fluidically favorable transition from the blade-like and relatively thin-walled turbine blades to the radial extensions that then widen in cross-section towards the blade root region. These radial extensions, which widen in cross-section towards the shaft region, in turn facilitate a structurally secure connection of the turbine blade to the optionally circular or annular shaft region.

According to a second aspect, the present invention relates to an arrangement. The arrangement includes at least one turbine wheel and one compressor wheel, wherein the turbine wheel and the compressor wheel are connected to each other by at least one shaft or can be connected to each other by way of a two-part shaft unit, wherein the turbine wheel is designed according to one of the optional further developments described above.

According to the second aspect, the present invention thus provides that, in an arrangement consisting of at least one turbine wheel and a compressor wheel, the turbine wheel is designed according to the characteristics of described above or according to one of the further developments. The arrangement is optionally an element of a turbocharger of a vehicle, in particular a motor vehicle.

An arrangement equipped with a turbine wheel designed according to the present invention has, on the one hand, a reduced mass compared to an arrangement with a turbine wheel made of solid material, due to the gyroidal structure forming the regions of the shaft region and the blade root region.

In an arrangement designed according to the present invention, a reduced mass inertia of the arrangement, which is to be set into a rotational movement with varying speed, is moreover achieved by way of a mass flow directed in particular over the turbine wheel.” A turbine equipped with such an arrangement exhibits improved dynamic response. Moreover, alternating torques and forces acting on the arrangement can be absorbed without hindrance and transmitted safely and in a controlled manner via the gyroidal spatial structure in the shaft and blade root region of the wheel body to a shaft that can be coupled to the shaft region in a rotationally fixed manner. Optionally, sections or regions of the wheel body wall restricting the cavity, as well as of the gyroidal structure, in particular its ribs, within the cavity in the shaft and blade root region of the wheel body are individually adapted to the forces expected to act on the turbine wheel.

According to an optional aspect, a further development of the present invention relates to a turbocharger, in particular an exhaust gas turbocharger, for a vehicle, including at least one turbine wheel according to one of the optional further developments previously described, or a turbocharger, in particular an exhaust gas turbocharger, with an arrangement according to the features of the second aspect of the present invention as described herein.

The optional embodiments and further developments described for the turbine wheel according to the first aspect of the present invention are also optional embodiments and further developments of the arrangement according to the second aspect and of the turbocharger according to the third aspect.

Embodiments of an inventive turbine wheel, an inventive arrangement, or a turbocharger according to the present invention are described below with reference to the drawings. These drawings are not necessarily intended to represent the embodiments to scale; rather, where helpful for clarification, the drawings are presented in a schematic and/or slightly distorted form. For further information on the teachings directly apparent from the drawings, reference is made to the relevant state of the art. It should be noted that numerous modifications and changes concerning the form and details of an embodiment can be made without deviating from the general idea of the invention. The features of the invention disclosed in the description, the drawings, and the claims can be essential for the further development of the invention, both individually and in any combination. Moreover, all combinations of at least two of the features disclosed in the description, the drawings, and/or the claims fall within the scope of the invention. The general idea of the invention is not limited to the exact form or details of the optional embodiment shown and described below, nor is it limited to an object that would be restricted compared to the object claimed in the claims. For specified design ranges, values within the stated limits should also be disclosed as limit values and be freely usable and claimable.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a sectional view of a turbocharger with an arrangement of a turbine wheel according to the concept of the invention;

FIG. 2 is a first optional embodiment of a turbine wheel according to the concept of the invention in a first variant in a sectional view transverse to its longitudinal axis;

FIG. 3 is a modified first optional embodiment of a turbine wheel according to the concept of the invention in a second variant in a sectional view transverse to its longitudinal axis;

FIG. 4 is a second optional embodiment of a turbine wheel according to the concept of the invention in a partial sectional view of a segment of the turbine wheel parallel to the longitudinal axis.

Corresponding reference characters indicate corresponding parts throughout the several views. The exemplifications set out herein illustrate embodiment of the invention, and such exemplifications are not to be construed as limiting the scope of the invention in any manner.

### DETAILED DESCRIPTION OF THE INVENTION

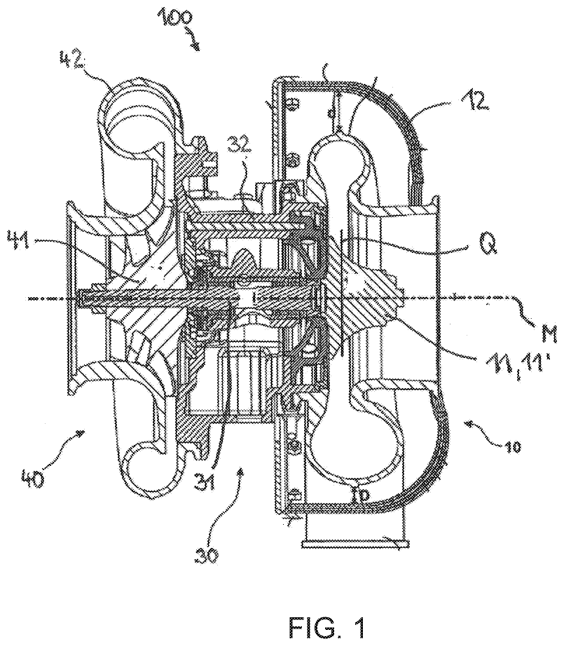

FIG. 1 shows a turbocharger 100, in particular an exhaust gas turbocharger for a motor vehicle, including a turbine 10, in particular an exhaust gas turbine, a bearing unit 30, and a compressor 40. Turbine 10 includes a turbine wheel 11 which is only shown schematically, and compressor 40 includes a compressor wheel 41, wherein turbine wheel 11 and compressor wheel 41 are rotatably mounted on a shaft 31 within a bearing housing 32 of bearing unit 30. Compressor wheel 41 is arranged in a compressor housing 42. Compressor 40 is designed as a radial compressor, through which an airflow flows axially and exits compressor housing 42 in radial direction due to deflection of compressor wheel 41.

Turbine wheel 11 of turbine 10 is arranged in a turbine housing 12, which is also designed as a radial housing. An exhaust gas flow from a combustion engine that is not shown in detail is introduced into turbine housing 12. The exhaust gas flow enters turbine housing 12 radially and exits turbine housing 12 in an axial direction approximately parallel to central axis M. When the exhaust gas flow passes through turbine housing 12, the kinetic energy contained in the exhaust gas flow is converted into a rotary movement of turbine wheel 11, which in turn is used to drive compressor wheel 41.

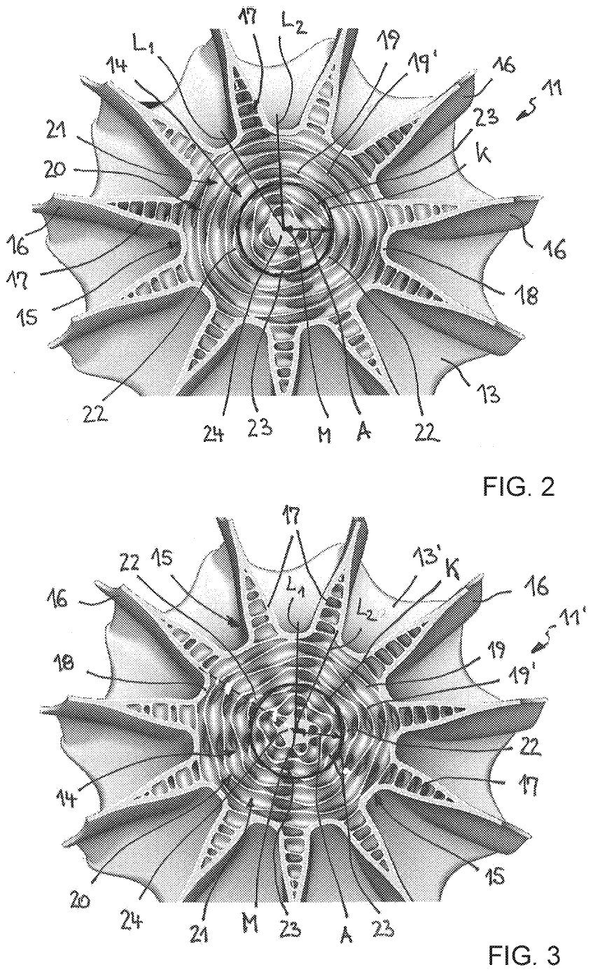

FIG. 2 shows a first embodiment of a turbine wheel 11, which has a wheel body 13 including at least a central shaft region 14, a blade root region 15 and a number of turbine blades 16.

Blade root region 15 also has a number of radial extensions 17 assigned to turbine blades 16, each of which connects radially to central shaft region 14 extending around central axis M of wheel body 13. Radial extensions 17 are integrally connected to shaft region 14, with each radial extension 17 having an integral connection to a turbine blade 16.

Shaft region 14 and blade root region 15 have a cavity 21, which is restricted by a wheel body wall 18 defining the outer structure of wheel body 12 and is traversed by a number of ribs 19 of a gyroidal structure 20. Ribs 19 within cavity 21 have a rib wall thickness S_{B}, and heel central wall 18 has a wheel body wall thickness R_{B}. Wall thickness S_{B}, R_{B} of ribs 19 and/or wheel central wall 18 or the density of gyroidal structure 20 in cavity 21 are defined depending on the forces acting on wheel body 13 during operation of turbine wheel 11. Wall thickness S_{B} of ribs 19 of structure 21 varies from rib to rib, and wall thickness R_{B} of the wheel body wall varies from wall to wall.

As can be seen from FIG. 2, structure 20 in cavity 21, with respect to a cross-section Q extending perpendicularly through gyroidal structure 20 and perpendicular to central axis M, has several ribs 19 extending around central axis M. Ribs 19, which are particularly closed, each oscillate in a wave-like manner around a circular line K assigned to each rib 19, wherein each circular line K—one of which is shown by way of example in FIGS. 2 and 3—extend around central axis M at a distance A.

In the embodiment shown in FIG. 2, ribs 19 have an arc number of 3, with which ribs 19 oscillate around the respective assigned circular line K. Each rib 19 has, according to its number of arcs, a defined number of wave crests 22 projecting radially outward beyond the circular line K and wave troughs 23 projecting radially inward. The size of wave crests 22 and wave troughs 23 of ribs 19 relative to circular line K decreases with increasing distance of ribs 19 from central axis M.

Wave crests 22 and wave troughs 23 of two ribs arranged in a radial direction adjacent to each other are offset by a predetermined angle to each other. In the present case, the angular offset of two wave crests 22 and two wave troughs 23 of adjacent ribs 19 is in a range of about 10 to 20 degrees.

FIG. 3 shows a further embodiment of a turbine wheel 11′ according to the present invention, including a wheel body 13′ with a shaft section 14, a blade root section 15, and turbine blades 16. In contrast to the previous embodiment, gyroidal structure 20′ in cavity 21 of the wheel body 13′ has ribs 19′ which also oscillate in a wave-like manner around a circular line K assigned to a respective rib. Unlike ribs 19 of wheel body 13, ribs 19′ of wheel body 13′ oscillate with an odd arc number of 5 around the respectively assigned circular lines K. The embodiment shown in FIG. 3 thus has, corresponding to its number of arcs, five wave crests 22 projecting radially outward across circular line K and five wave troughs 23 projecting radially inward across circular line K. The size of wave crests 22 and wave troughs 23 of the ribs 19 decreases again with increasing distance of ribs 19′ from central axis M to circular line K.

Regarding additional features that fundamentally define turbine wheel 11′, reference is made to the descriptions of turbine wheel 11 according to FIG. 2, which are fundamentally similar. Both embodiments of turbine wheels 11, 11′ shown in FIG. 2 and FIG. 3 form a central region 24, 24′ made of solid material around central axis M.

In both embodiments of turbine wheels 11, 11′ shown in FIG. 2 and FIG. 3, odd-numbered ribs 19, 19′ progressing around central axis M form a first group of ribs, and even-numbered ribs 19, 19′ progressing around central axis M form a second group of ribs, wherein wave crests 22 and wave troughs 23 of the first group and the second group respectively are on different axes L₁, L₂ extending radially from the central axis M.

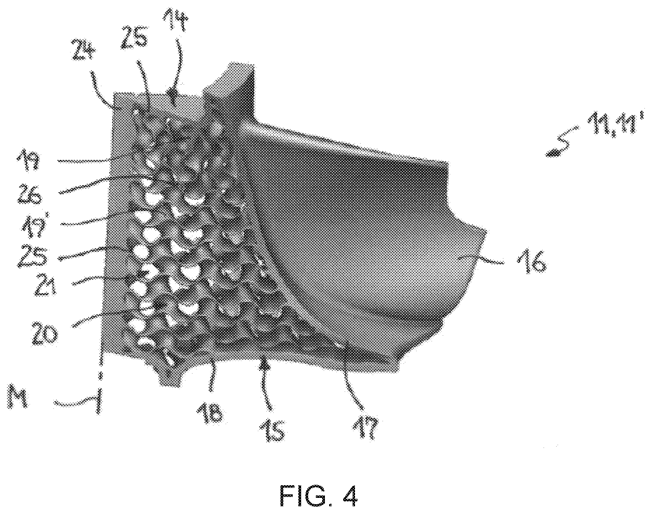

FIG. 4 shows an enlarged detail view of a segment of a turbine wheel 11, 11′. Ribs 19, 19′ of gyroidal structure 20, 20′ and/or wheel body wall 18 have a wall thickness S_{B}, R_{B} that varies along their length. In particular, ribs 19, 19′ of gyroidal structure 20 and wheel body wall 18 extend axially, radially, and/or circumferentially with respect to central axis M of wheel body 13, 13′. Ribs 19, 19′ are thicker, especially in root region 25, that is, in the connection regions of ribs 19, 19′ to wheel body wall 18, and form junction points 26 with each other, which are also reinforced.

As can also be seen from FIG. 4, the density of gyroidal structure 20 can change in the radial and/or axial direction with respect to central axis M of wheel body 13, 13′. Moreover, wall thickness S_{B} of ribs 19, 19′ that are closest to central axis M is greater than the wall thickness S_{B} of ribs 19, 19′ that are furthest from central axis M. Optionally, wall thickness S_{B} of ribs 19, 19′ decreases linearly outwards in the radial direction.

Depending on their distance from the central axis and the forces acting on turbine wheel 11, 11′, the ribs can, for example, have a wall thickness of 1 to 6 mm. A turbine wheel 11, 11′ with a gyroidal structure 20, 20′ according to the present invention has a mass that is at least 15% lower than the mass of a turbine wheel made of solid material, at least 30% lower in an optional embodiment, and up to 50% lower in an optional embodiment.

### COMPONENT REFERENCE LISTING

10 Turbine
11, 11′ Turbine wheel
12 turbine housings
13, 13′ wheel body
14 shaft range
15 blade foot region
16 turbine blades
17 radial extension
18 wheel body wall
19, 19′ ribs
20, 20′ gyroidal structure
21 cavity
22 wave crest
23 wave troughs
24 central region
25 root region
26 junction point
30 bearing unit
31 shaft
32 bearing housings
40 compressor
41 compressor wheel
42 compressor housings
100 turbocharger
A distance
K circular line
L₁, L₂ axis
M center axis
S_{B} wall thickness, rib
R_{B} wall thickness, wheel body wall
Q Cross-section

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A turbine wheel of a turbine of a turbocharger for a vehicle, the turbine wheel comprising:
a wheel body formed as a single-piece wheel body, the wheel body being configured for being rotatably arranged in a turbine housing and for being at least rotationally fixed to a shaft, the wheel body including a central shaft region, a blade root region, and a plurality of turbine blades, the blade root region including a plurality of radial extensions associated with the plurality of turbine blades, each of the plurality of radial extensions connecting radially to the central shaft region which extends about a central axis of the wheel body and being integrally connected with the central shaft region, the plurality of turbine blades being respectively integrally connected to the plurality of radial extensions, the wheel body including a wheel body wall that defines an outer structure of the wheel body; and
a gyroidal structure including a plurality of ribs, the central shaft region and the blade root region including a cavity limited by the wheel body wall defining the outer structure of the wheel body and traversed by the plurality of ribs of the gyroidal structure, the plurality of ribs within the cavity including a rib wall thickness, the wheel body wall including a wheel body wall thickness, at least one of (i) at least one of the rib wall thickness of the plurality of ribs and the wheel body wall thickness of the wheel body wall and (ii) a density of the gyroidal structure extending within the cavity is load-dependent with respect to a plurality of forces acting on the wheel body during operation of the turbine wheel.

2. The turbine wheel according to claim 1, wherein at least one of:
the rib wall thickness of the plurality of ribs of the gyroidal structure at least one of differs with respect to each of the plurality of ribs, and/or is different from the wheel body wall thickness of the wheel body wall; and
the wheel body includes a plurality of the wheel body wall, the wheel body wall thickness of the wheel body wall differing with respect to each of the plurality of wheel body walls.

3. The turbine wheel according to claim 1, wherein the density of the gyroidal structure within the cavity varies.

4. The turbine wheel according to claim 1, wherein at least one of (i) the rib wall thickness of the plurality of ribs of the gyroidal structure and (ii) the wheel body wall thickness of the wheel body wall varies along a respective extent of the plurality of ribs.

5. The turbine wheel according to claim 1, wherein the density of the gyroidal structure varies in at least one of a radial direction and an axial direction relative to the central axis of the wheel body.

6. The turbine wheel according to claim 5, wherein the density of the gyroidal structure changes depending on a distance to the central axis.

7. The turbine wheel according to claim 6, wherein the density decreases as the distance to the central axis increases.

8. The turbine wheel according to claim 1, wherein the central shaft region is at least one of circular and annular around the central axis of the wheel body.

9. The turbine wheel according to claim 8, wherein the central shaft region is arranged concentrically around the central axis together with the blade root region.

10. The turbine wheel according to claim 1, wherein a ratio of a respective said rib wall thickness of respective ones of the plurality of ribs that are closest to the central axis to a respective said rib wall thickness of respective ones of the plurality of ribs that are furthest from the central axis is in a range of about 0.25 to about 0.6.

11. The turbine wheel according to claim 10, wherein the rib wall thickness of the plurality of ribs that are closest to the central axis is about 1 to 6 mm.

12. The turbine wheel according to claim 1, wherein the turbine wheel, with the gyroidal structure, which includes at least one main gyroid, has a mass whose ratio to a mass of another turbine wheel made of a solid material of a same size as the turbine wheel is in a range of 0.5 to 0.85.

13. The turbine wheel according to claim 1, wherein the gyroidal structure, with respect to a cross-section perpendicular to the central axis, has the plurality of ribs extending around the central axis, wherein each of the plurality of ribs oscillate in a wave-like manner about a respective circular line associated with a respective one of the plurality of ribs, wherein each said circular line extends around the central axis at different distances.

14. The turbine wheel according to claim 13, wherein each of the plurality of ribs oscillate around the respective circular line assigned thereto with an odd number of arcs of 3, 5, or 7.

15. The turbine wheel according to claim 13, wherein each of the plurality of ribs has a plurality of wave crests projecting radially outward from the respective circular line and a plurality of wave troughs projecting radially inward from the respective circular line, the plurality of wave crests and the plurality of wave troughs being defined according to a number of arcs respectively, wherein a size of the plurality of wave crests and the plurality of the wave troughs of the plurality of ribs relative to the respective circular line decreases with an increasing distance of the plurality of ribs respectively from the central axis.

16. The turbine wheel according to claim 15, wherein the plurality of wave crests respectively or the plurality of wave troughs respectively of two of the plurality of ribs arranged in a radial direction adjacent to each other are offset by a predetermined angle to each other, with an angular offset in a range of approximately 10 to 20 degrees.

17. The turbine wheel according to claim 13, wherein an odd number of the plurality of ribs extending around the central axis forms a first group of ribs, and an even number of the plurality of ribs extending around the central axis forms a second group of ribs, wherein respective ones of the plurality of wave crests and respective ones of the plurality of wave troughs of the first group and the second group lie on respectively different axes extending radially from the central axis.

18. The turbine wheel according to claim 1, wherein the plurality of radial extensions of the blade root region taper cross-sectionally and thereby structurally and integrally connect the central shaft region to the plurality of turbine blades.

19. The turbine wheel according to claim 18, wherein the plurality of radial sections form a tapered cross-section, wherein the plurality of turbine blades adjoin the tapered cross-section of the plurality of radial extensions in a blade-like manner.

20. An arrangement, comprising:
at least one turbine wheel of a turbine of a turbocharger for a vehicle, the at least one turbine wheel including:
a wheel body formed as a single-piece wheel body, the wheel body being configured for being rotatably arranged in a turbine housing and for being at least rotationally fixed to a shaft, the wheel body including a central shaft region, a blade root region, and a plurality of turbine blades, the blade root region including a plurality of radial extensions associated with the plurality of turbine blades, each of the plurality of radial extensions connecting radially to the central shaft region which extends about a central axis of the wheel body and being integrally connected with the central shaft region, the plurality of turbine blades being respectively integrally connected to the plurality of radial extensions, the wheel body including a wheel body wall that defines an outer structure of the wheel body; and
a gyroidal structure including a plurality of ribs, the central shaft region and the blade root region including a cavity limited by the wheel body wall defining the outer structure of the wheel body and traversed by the plurality of ribs of the gyroidal structure, the plurality of ribs within the cavity including a rib wall thickness, the wheel body wall including a wheel body wall thickness, at least one of (i) at least one of the rib wall thickness of the plurality of ribs and the wheel body wall thickness of the wheel body wall and (ii) a density of the gyroidal structure extending within the cavity is load-dependent with respect to a plurality of forces acting on the wheel body during operation of the at least one turbine wheel; and
a compressor wheel, the at least one turbine wheel and the compressor wheel being connected to each other by at least one shaft or by a two-part shaft unit.
